(19) United States
(12) Patent Application Publication
(10) Pub. No.: US 2013/0209762 A1
(43) Pub. Date: Aug. 15, 2013

(54) GLASS-CERAMIC WHICH IS AT LEAST PARTLY PROVIDED WITH A HARD MATERIAL LAYER

(71) Applicants: Thorsten DAMM, Nieder-Olm (DE); Hrabanus HACK, Mainz (DE); Christian HENN, Frei-Laubersheim (DE)

(72) Inventors: Thorsten DAMM, Nieder-Olm (DE); Hrabanus HACK, Mainz (DE); Christian HENN, Frei-Laubersheim (DE)

(73) Assignee: SCHOTT AG, Mainz (DE)

(21) Appl. No.: 13/587,282

(22) Filed: Aug. 16, 2012

(30) Foreign Application Priority Data
Aug. 19, 2011 (DE) 10 2011 081 234.2

(51) Int. Cl. C03C 17/22

(52) U.S. Cl. CPC C03C 17/225
USPC 428/212

(57) ABSTRACT

Glass-ceramic is provided that is at least partly provided with a hard material layer to protect against external mechanical influences. The hard material layer contains at least two phases, which are present side by side and are mixed with one another. The at least two phases include at least one nanocrystalline phase and one amorphous phase. The hard material layer has a hardness of at least 26 GPa and a layer thickness of at least 0.5 μm. The hard material layer is chemically resistant in the temperature range from 200° C. to 1000° C. The coefficient of thermal expansion (α) of the glass-ceramic does not differ by more than +/−20% from the coefficient of thermal expansion (α) of the hard material layer.

### CROSS REFERENCE TO RELATED APPLICATIONS

This application claims benefit under 35 U.S.C. §119(a) of German Patent Application No. 10 2011 081 234.2, filed Aug. 19, 2011, the entire contents of which are incorporated herein by reference.

### BACKGROUND OF THE INVENTION

1. Field of the Invention

The invention relates to a glass-ceramic which is at least partly provided with a hard material layer which protects against external mechanical influences.

2. Description of Related Art

To preserve, for example, the high-class appearance of cooking surfaces made of glass-ceramic even after a number of years of use, the surface of the glassceramic has to be protected against external mechanical influences. Even during normal use, scratches can occur on the surface of the glass-ceramic by sliding of objects (pots, bowls, etc.) and have an adverse effect on the appearance and impair easy cleanability and mechanical resistance of the surface. For this reason, cooking surfaces made of glass-ceramic are provided with a hard material layer which protects against external mechanical influences. Thus, glass-ceramic articles coated with hard material are known from WO 2009/010180 A1. In order to protect a glass-ceramic article against external mechanical influences, it is proposed in this document that a silicon nitride layer be deposited as hard material layer on a glass-ceramic substrate, with the silicon nitride layer having an X-ray-amorphous morphology in its volume.

Coated glass substrates are known from EP 1 705 162 A1, and coated substrates of glass or glass-ceramic are known from EP 1 514 852 A1.

### SUMMARY

Proceeding from this prior art, it is an object of the invention to provide improved glass-ceramics which are at least partly provided with a hard material layer which protects against external mechanical influences. The glass-ceramics should be protected even better and more durably than before against external mechanical influences and offer optimal mechanical resistance to stresses in daily use. The surface of the glass-ceramic should also withstand cleaning with abrasive cleaners such as SiC-containing liquids, SiC-containing sponges or SiC containing cleaning cloths without damage.

A further object of the invention is to match the glass-ceramic to the respective visual requirements.

This object is achieved by a glass-ceramic which is at least partly provided with a hard material layer which protects against external mechanical influences, wherein the hard material layer contains at least two phases which are present side by side and are mixed with one another, at least one nanocrystalline phase and one amorphous phase are present, the hard material layer has a hardness of at least 26 Gigapascal (GPa) and a layer thickness of at least 0.5 micrometer (μm) the hard material layer is chemically resistant in the temperature range from 200 degrees Celsius (° C.) to 1000° C., and the coefficient of thermal expansion (α) of the glass-ceramic differs by not more than +/−20% from the coefficient of thermal expansion (α) of the hard material layer.

### DETAILED DESCRIPTION

It has been found in comparative tests that the glass-ceramics which have been coated according to the invention can be protected better and more durably against external mechanical influences than has hitherto been possible according to the abovementioned prior art.

The coefficient of thermal expansion (α) of the glass-ceramic differs, in particular, by not more than +/−20% from the coefficient of thermal expansion (α) of the hard material layer in the temperature range from 200° C. to 1000° C.

The coefficient of thermal expansion (α) of the glass-ceramic particularly preferably differs by not more than +/−10% from the coefficient of thermal expansion (α) of the hard material layer.

In general, the term glass refers to soda-lime glass (SL glass) which has a high coefficient of thermal expansion (α) of about 9.0×10⁻⁶/K. The coefficients of thermal expansion (α) of the layer materials can be identical (e.g. α of TiN: 9.35×10⁻⁶/K) or else differ considerably therefrom (α of SbN4: about 3×10⁻⁶/K, α of AlN: about 4×10⁻⁶/K). The greater the difference between the coefficients of thermal expansion (α) of layer and substrate, the more stress is built up at the interface. When the difference is too great, delamination occurs. If the coated SL glass is subjected to a high temperature it expands to a greater extent than the layer, which leads to an additional stress at the glass/layer interface and promotes delamination. The use of a glass-ceramic having virtually zero expansion is advantageous for use in the high-temperature range for two reasons: this substrate can be used at significantly higher temperatures than normal glass and the lower thermal expansion (α) of the substrate causes a significantly lower stress at the interface to the coating, as a result of which the risk of delamination is low. It is clear to see that the significant thermal expansion (α) of a glass substrate likewise significantly extends the layer, as a result of which crack formation easily occurs and the penetration of atmospheric moisture promotes delamination of the layer. On the other hand, if the substrate expands less than the layer, this leads to a compressive stress (which in the case of sputtered layers is already present due to the method of production), but not to severe mechanical deformation.

The average grain size of the nanocrystalline phase is preferably less than 1000 nanometers (nm), more preferably less than 100 nm and particularly preferably from 1 nm to 50 nm.

In a further preferred embodiment, the amorphous phase substantially surrounds the nanocrystalline phase, i.e. at least 50%, preferably at least 75%, of the surface of the nanocrystalline phase is surround by the amorphous phase. The amorphous phase thus forms a type of matrix which surrounds the crystal grains of the nanocrystalline phase. The extraordinarily high hardness of the layer is produced by this nanostructure which has both an ideally perfectly nanocrystalline phase and an amorphous phase (matrix).

In a further preferred embodiment, the amorphous phase substantially surrounds the nanocrystalline phase.

The hard material layer preferably has a light transmission in the wavelength range from 380 nm to 780 nm of at least 80% at a layer thickness of 1.0 μm.

To obtain good and durable protection of the glass-ceramic, the nanocrystalline phase and/or the amorphous phase preferably consist(s) of a nitridic or oxidic compound, in particular of aluminium nitride and/or oxide, silicon nitride and/or oxide, boron nitride and/or oxide, zirconium nitride and/or oxide and/or titanium nitride and/or oxide, or the nanocrystalline phase comprises a nitridic or oxidic compound.

Furthermore, the hard material layer can have a hardness of at least 28 GPa, in particular from 30 GPa to 50 GPa, in order to obtain good and durable protection.

The hard material layer can be provided with at least one further layer, in particular an antireflection layer. However, the hard material layer can itself also be part of an antireflection layer.

The antireflection layer can consist entirely of nanocomposites.

The refractive index (n_{D}) of a preferred hard material layer is generally above 2.0. The hard material layer is therefore visually conspicuous in the form of a slightly reflective surface. Should this conspicuous nature be undesirable, the hard material layer can be embedded in a layer system for reducing reflection, i.e. an antireflection layer, or be provided with an antireflection layer. In this case, layers having high and low refractive indices, e.g. hard material layer and SiO₂ layer, are applied alternately in precisely defined layer thickness ratios to the glassceramic. A satisfactory antireflection action can be achieved with only four alternating layers. The uppermost layer has to consist of the material having the low refractive index.

The glass-ceramic is preferably a cooking surface, a viewing window, in particular a chimney viewing window, a protective plate or a covering plate.

The glass-ceramic is preferably a lithium-aluminium silicate glass-ceramic.

The hard material layer preferably has a layer thickness of at least 0.5 μm, preferably from at least 1.0 μm to 10 μm. Here, the thicker the layer, the harder it is. The layer thickness can in general be selected so that it meets the respective mechanical and/or optical requirements.

If the hard material layer is part of an (optical) layer system, e.g. an antireflection layer, the total thickness of the system is typically less than one micron.

For the glass-ceramic of the invention to be recognizable as such, in particular for the glass-ceramic of the invention to be at least partly recognizably provided with a hard material layer which protects against external mechanical influences, the refractive index (n_{D}) of the hard material layer is preferably set to a value above the refractive index (n_{D}) of the respective glass-ceramic. Preference is given to setting a refractive index (n_{D}) of over 1.44, particularly preferably a refractive index (n_{D}) of over 1.49. Measurement wavelength of sodium D line 589 nm.

The hard material layer is preferably applied to at least the part of the glassceramic which is to be protected against external mechanical influences.

Furthermore, at least one bonding layer, a barrier layer and/or a decorative layer can be arranged between glass-ceramic and hard material layer.

In a further glass-ceramic according to the invention, the proportion of the crystalline phase can be greater than that of the amorphous phase in the hard material layer; in particular, the proportion of the crystalline phase can be greater than 50 mol % and preferably be at least 75 mol % and particularly preferably at least 85 mol %, especially in order to achieve hardnesses of at least 26 GPa in a simple way.

The hard material layer preferably has a light transmission in the wavelength range from 1 μm to 20 μm of at least 50%, preferably at least 65%, and particularly preferably at least 80%. Coating has to be carried out using materials which have a high transparency in the wavelength range from 1 μm to 20 μm. For example, AlN and Si₃N₄ meet this requirement. The average transmission should be above 50%, better above 65%, even better above 80%, and the transmission should ideally be at its greatest in the region of the radiation maximum.

In a further glass-ceramic according to the invention, the nanocrystalline phase or/and the amorphous phase can consist of more than two materials.

In a further glass-ceramic according to the invention, the nanocrystalline phase can consist mainly of aluminium nitride and the amorphous phase can consist mainly of silicon nitride and at least one of the two phases can contain oxygen ions in addition to nitride ions.

The high hardness of the nanocomposite layers is generally explained by a two phase system which consists of two immiscible materials. Impurities in the subpercent range (atom per cent) reduce the tremendous hardnesses. It has astonishingly been found that oxynitride systems also have a comparatively high hardness. For example, hardnesses of over 26 GPa can be achieved by means of the system AlSiON. The proportion of oxygen was up to 15 mol %. While AlN and Si₃N₄ are immiscible, Al and Si and their oxides are miscible. The precise cause of the hardness is not known precisely. Some oxygen possibly promotes the growth of small crystallites by serving as crystallization nucleus for growth.

### EXAMPLES

Glass-ceramics comprising hard material layers containing, in particular, nonoxidic, ternary and quaternary nanocomposites have excellent mechanical, thermal and optical properties. For the present purposes, nanocomposites are materials systems which have at least two phases having an average grain size of less than 1000 nm.

Layer hardnesses of over 28 GPa, in particular in the range from 30 GPa to 50 GPa, and thermal stabilities to above 1000° C. can readily be achieved. The particular layer properties are brought about by, in particular, the formation of very small crystallites embedded in an amorphous matrix.

The crystallite size was preferably in the region of a few nanometres (in particular in the range from 5 nm to 20 nm), and the amorphous matrix was preferably very thin and enclosed the individual crystallites with a few layers or in the ideal case a single monolayer.

All hard material layers composed of the compounds mentioned, in particular nitrides of Al, Si, B, Ti, are highly refractive, i.e. have a refractive index greater than that of conventional glass-ceramic substrates. As a result, light in the visible wavelength range is reflected to a greater extent by the hard material layer, so that the hard material coating is visible.

Nitrides containing Al, Si, B, Ti and Zr are used for producing the hard material layers; the combinations Al—Si—N and Si—B—C—N have been found to be particularly suitable.

To form the particularly hard nanocomposite, it was necessary for the materials used to have a low solubility in one another, e.g. titanium nitride and silicon nitride or aluminium nitride and silicon nitride. Mixed phases lead to a reduction in hardness.

The sputtering process, inter alia, was suitable for applying a hard material layer having the required nanostructure. Here, deposition of the hard material layer should take place well away from the thermodynamic equilibrium so as not just to produce a simple “alloy” of the materials. Coating with hard material at elevated temperature (>100° C., preferably >200° C., particularly preferably >300° C.) and/or coating with the aid of ion bombardment (e.g. from an ion beam source of by application of a substrate bias) was thus advantageous. High-energy particles during the sputtering process could also be generated by the HiPIMS process. A combination of the abovementioned techniques can likewise be advantageous (e.g. HiPIMS and bias or increased deposition temperature and bias). The increased ion energy in the HiPIMS process can in some cases lead to a nanocomposite being formed even at a relatively low substrate temperature (<100° C., preferably close to room temperature).

The transparent hard material layers generally have a higher refractive index than the glass or glass-ceramic substrate and can therefore be recognized on the substrate by their slightly reflective effect.

On the other hand, if the reflective impression was perceived as undesirable, an antireflection layer system which is composed of layers having high and low refractive indices and consists either entirely or only partly of nanocomposite layers could be produced.

What is claimed is:

1. A glass-ceramic comprising:
a hard material layer that protects against external mechanical influences at least partially provided on the glass-ceramic,
wherein the hard material layer comprises at least two phases that are present side by side and are mixed with one another, the at least two phases comprising at least one nanocrystalline phase and one amorphous phase,
wherein the hard material layer has a hardness of at least 26 GPa and a layer thickness of at least 0.5 μm, is chemically resistant in the temperature range from 200° C. to 1000° C., and has a coefficient of thermal expansion (α) that does not differ by more than +/−20% from a coefficient of thermal expansion (α) of the glass-ceramic.

2. The glass-ceramic according to claim 1, wherein the nanocrystalline phase has an average grain size of less than 1000 nm.

3. The glass-ceramic according to claim 2, wherein the average grain size is between 1 nm to 50 nm.

4. The glass-ceramic according to claim 1, wherein the amorphous phase substantially surrounds the nanocrystalline phase.

5. The glass-ceramic according to claim 1, wherein the hard material layer has a light transmission in the wavelength range from 380 nm to 780 nm of at least 80% at a layer thickness of 1.0 μm.

6. The glass-ceramic according to claim 1, wherein the nanocrystalline phase and/or the amorphous phase comprises a material selected from the group consisting of a nitridic compound, an oxidic compound, aluminium nitride, aluminium oxide, silicon nitride, silicon oxide, boron nitride, boron oxide, zirconium nitride, zirconium oxide, titanium nitride, titanium oxide, and combinations thereof.

7. The glass-ceramic according to claim 1, wherein the hard material layer further comprises an antireflection layer.

8. The glass-ceramic according to claim 1, wherein the hard material layer is part of an antireflection layer.

9. The glass-ceramic according to claim 1, wherein the glass-ceramic is a cooking surface, a viewing window, a chimney viewing window, a protective plate, or a covering plate.

10. The glass-ceramic according to claim 1, wherein the glass-ceramic is a lithium-aluminium silicate glass-ceramic.

11. The glass-ceramic according to claim 1, wherein the hard material layer has a hardness of at least 28 GPa.

12. The glass-ceramic according to claim 1, wherein the hard material layer has a hardness between 30 GPa to 50 GPa.

13. The glass-ceramic according to claim 1, wherein the hard material layer has a layer thickness of between 1.0 μm to 10 μm.

14. The glass-ceramic according to claim 1, further comprising at least one bonding or barrier layer arranged between glass-ceramic and hard material layer.

15. The glass-ceramic according to claim 1, wherein the hard material layer has a refractive index (n_{D}) that is above a refractive index (n_{D}) of the glass-ceramic.

16. The glass-ceramic according to claim 1, wherein the hard material layer has a proportion of nanocrystalline phase that greater than the amorphous phase.

17. The glass-ceramic according to claim 16, wherein the hard material layer has a proportion of nanocrystalline phase that is more than 50 mol % greater than the amorphous phase.

18. The glass-ceramic according to claim 16, wherein the hard material layer has a proportion of nanocrystalline phase that is more than 85 mol % greater than the amorphous phase.

19. The glass-ceramic according to claim 1, wherein the hard material layer has a light transmission in the wavelength range from 1 μm to 20 μm of at least 50%.

20. The glass-ceramic according to claim 19, wherein the light transmission in the wavelength range from 1 μm to 20 μm is at least 80%.

21. The glass-ceramic according to claim 1, wherein the nanocrystalline phase comprises more than two materials.

22. The glass-ceramic according to claim 1, wherein the amorphous phase comprises more than two materials.

23. The glass-ceramic according to claim 1, wherein the nanocrystalline phase consists essentially of aluminium nitride and the amorphous phase consists essentially of silicon nitride, and wherein at least one of the two phases contains oxygen ions in addition to nitride ions.
